(19) United States
(12) Patent Application Publication
(10) Pub. No.: US 2026/0051548 A1
(43) Pub. Date: Feb. 19, 2026

(54) SECONDARY BATTERY AND ELECTRONIC APPARATUS

(71) Applicant: Xiamen Ampace Technology Limited, Xiamen (CN)

(72) Inventor: Jinfeng CHI, Xiamen (CN)

(73) Assignee: Xiamen Ampace Technology Limited, Xiamen (CN)

(21) Appl. No.: 19/362,821

(22) Filed: Oct. 20, 2025

Related U.S. Application Data
(63) Continuation of application No. PCT/CN2023/140135, filed on Dec. 20, 2023.

(30) Foreign Application Priority Data
Apr. 20, 2023 (CN) 202310429668.7

(51) Int. Cl. H01M 10/42; H01M 4/02; H01M 4/131; H01M 4/136; H01M 4/36; H01M 4/505; H01M 4/58; H01M 4/66; H01M 50/531; H01M 50/586; H01M 50/59

(52) U.S. Cl. CPC H01M 10/4235; H01M 4/131; H01M 4/136; H01M 4/364; H01M 4/505; H01M 4/5825; H01M 4/667; H01M 50/531; H01M 50/586; H01M 50/59; H01M 2004/021; H01M 2004/028

(57) ABSTRACT

A secondary battery includes a positive electrode plate. The positive electrode plate includes a current collector, a tab protruding from the current collector, and an insulation layer disposed on at least one surface of the current collector. The insulation layer is disposed along a side edge of the current collector and abutted against the active material layer; the tab protrudes from the side edge of the current collector; A ratio of a thickness of the insulation layer to a thickness of the active material layer is 0.5-0.7, and the thickness of the active material layer is 200-400 μm.

### CROSS-REFERENCE TO RELATED APPLICATIONS

This application is a continuation application of International Application No. PCT/CN2023/140135, filed on Dec. 20, 2023, which claims the benefit of priority of Chinese patent application 202310429668.7, filed on Apr. 20, 2023, the contents of which are incorporated herein by reference in its entirety.

### TECHNICAL FIELD

This application relates to the field of energy storage apparatuses, in particular to a secondary battery and an electronic apparatus including the secondary battery.

### BACKGROUND

The edge of an electrode plate of a battery is usually provided with an insulation layer for preventing burrs. An active material layer and the insulation layer are usually coated synchronously on the surface of a current collector of the electrode plate. However, in the drying process, the active material layer and the insulation layer may produce mutual infiltration and mixing at the boundary position, leading to blurring of the boundary position of the active material layer and the insulation layer after the final drying, so that the judgment of the position of the active material layer is biased, which affects the size of the electrode plate, and thus triggers the risk of the low capacitance of the battery.

### SUMMARY

One objective of this application is to provide a secondary battery and an electronic apparatus, which can solve the problem that the size of an electrode plate is affected by an interaction zone at the junction of an active material layer and an insulation layer.

A first aspect of this application provides a secondary battery, including a positive electrode plate. The positive electrode plate includes a current collector, a tab protruding from the current collector, and an insulation layer disposed on at least one surface of the current collector. The insulation layer is disposed along a side edge of the current collector and abutted against the active material layer; the tab protrudes from the side edge of the current collector; A ratio of a thickness of the insulation layer to a thickness of the active material layer is 0.5-0.7, and the thickness of the active material layer is 200-400 μm.

In the secondary battery provided in this application, the thickness of the active material layer is controlled to be 200-400 μm and the ratio of the thickness of the insulation layer to the thickness of the active material layer is controlled to be 0.5-0.7, so that the size of an interaction zone located at the junction position of the active material layer and the insulation layer formed by infiltration and mixing of active slurry and insulation slurry in the coating process can be reduced, and the effect of the interaction zone on the size of the electrode plate is improved.

According to some embodiments of this application, the ratio of the thickness of the insulation layer to the thickness of the active material layer is 0.6-0.7, which is more conductive to reducing the size of the interaction zone.

According to some embodiments of this application, the thickness of the active material layer is further controlled to be 200-370 μm, which further reduces the size of the interaction zone. Further, the thickness of the active material layer is controlled to be 200-280 μm, which further reduces the size of the interaction region.

According to some embodiments of this application, a coating weight of the active material layer is 427-740 mg/1540.25 mm², which is conductive to reducing the size of the interaction zone.

According to some embodiments of this application, the coating weight of the active material layer is 427-640 mg/1540.25 mm².

According to some embodiments of this application, a compaction density of the active material layer is 2.6-3 g/cm³, which is conductive to reducing the size of the interaction zone.

According to some embodiments of this application, the insulation layer includes inorganic particles, and the inorganic particles includes one or more of aluminum oxide, boehmite, zirconium oxide, boron oxide, or hexagonal boron nitride.

According to some embodiments of this application, the active material layer includes an active material, and the active material includes one or more of lithium nickel cobalt manganese, lithium manganate, lithium iron phosphate, or lithium manganese iron phosphate.

According to some embodiments of this application, the active material is consist of the lithium manganate and the lithium iron phosphate, and a mass ratio of the lithium manganate to the lithium iron phosphate is 3.5-12, which enables a width of the interaction zone of the secondary battery to be proper and a thickness expansion rate of the secondary battery after storage to be proper.

According to some embodiments of this application, the active material includes the lithium manganate and the lithium iron phosphate, and the mass ratio of the lithium manganate to the lithium iron phosphate is 4-10, which further reduces the thickness expansion rate of the secondary battery after storage.

A second aspect of this application provides an electronic apparatus, including the secondary battery according to any one of the above embodiments.

### BRIEF DESCRIPTION OF DRAWINGS

The foregoing and/or additional aspects and advantages of this application will become apparent and readily understood from the description of the embodiments in conjunction with the following accompanying drawings.

FIG. 1 is a schematic diagram of a partial plane of a positive electrode plate provided by an embodiment of this application.

FIG. 2 is a cross-sectional schematic diagram of the positive electrode plate shown in FIG. 1 along II-II.

### REFERENCE NUMERAL DESCRIPTION OF MAIN COMPONENTS

| | |
|---|---|
| Positive electrode plate | 10 |
| Current collector | 11 |
| Tab | 12 |
| Active material layer | 13 |
| Insulation layer | 14 |
| First surface | 11a |
| Second surface | 11b |

### DETAILED DESCRIPTION

The technical solutions in the embodiments of this application are described clearly in detail below. Apparently, the described embodiments are some rather than all of the embodiments of this application. Unless otherwise defined, all technical and scientific terms used herein have the same meanings as commonly understood by a person skilled in the technical field to which this application pertains. The terms used in the specification of this application are merely for the purpose of describing specific embodiments and are not intended to limit this application.

Hereinafter, implementations of this application will be described in detail. However, this application may be embodied in many different forms and can not be construed as limited to exemplary implementations illustrated herein. Instead, these exemplary implementations are provided so that this application is communicated thoroughly and in detail to those skilled in the art.

In addition, for brevity and clarity, the size or thickness of various components and layers may be enlarged in the accompanying drawings. Throughout the text, the same values refer to the same elements. As used herein, the term “and/or” includes any and all combinations of one or more of relevant listed items. In addition, it should be understood that when element A is referred to as “connecting” element B, element A may be directly connected to element B, or there may be an intermediate element C and elements A and B may be indirectly connected to each other.

Further, the use of “may” when describing the implementations of this application means “one or more implementations of this application.

The technical terms used herein are for the purpose of describing specific implementations and are not intended to limit this application. As used herein, the singular form is intended to include the plural form as well, unless the context explicitly states otherwise. It is to be further understood that the term “include”, when used in the specification, refers to the presence of described features, values, steps, operations, elements and/or components, but does not exclude the presence or addition of one or more other features, values, steps, operations, elements, components and/or combinations thereof.

Spatially related terms such as “up” may be used herein to facilitate descriptions of an element or feature in relation to another element (a plurality of elements) or feature (a plurality of features) as illustrated in the figures. It should be understood that, in addition to the directions depicted in the figures, the spatially related terms are intended to encompass different directions of a device or apparatus in use or operation. For example, if the device in the figure is turned over, elements described as being “above” or “on” other elements or features will be oriented “below” or “under” the other elements or features. Thus, the exemplary term “up” may include both above and below directions. It should be understood that while the terms first, second, third, etc. may be used herein to describe various elements, components, regions, layers and/or portions, such elements, components, regions, layers and/or portions should not be limited by these terms. These terms are used to distinguish one element, component, region, layer or portion from another element, component, region, layer or portion. Accordingly, the first element, component, region, layer, or portion discussed below may be referred to as a second element, component, region, layer, or portion without departing from the teachings of the exemplary implementations.

In the prior art, as people's demand for high energy density batteries increases, it is usually necessary to set a larger coating weight of active material layer on an electrode plate to realize the improvement of the battery capacity, and the larger coating weight will lead to a larger thickness of the active material layer. An applicant finds that when the active material layer with the larger thickness is coated and formed, the boundary position of the active material layer and the insulation layer blurs, and the active material layer and an insulation layer may produce mutual infiltration and mixing at the boundary position to form an interaction zone, which affects the size of the electrode plate.

Based on the above problems found by the applicant, the applicant improves the thicknesses of the active material layer and the insulation layer of the electrode plate in order to reduce the size of the interaction zone, and thus reduce the effect on the size of the electrode plate due to the presence of the interaction zone. Embodiments of this application are further described below.

One embodiment of this application provides a secondary battery, including a shell, and a positive electrode plate, a negative electrode plate, a separator and an electrolytic solution which are contained in the shell, and the separator is disposed between the positive electrode plate and the negative electrode plate.

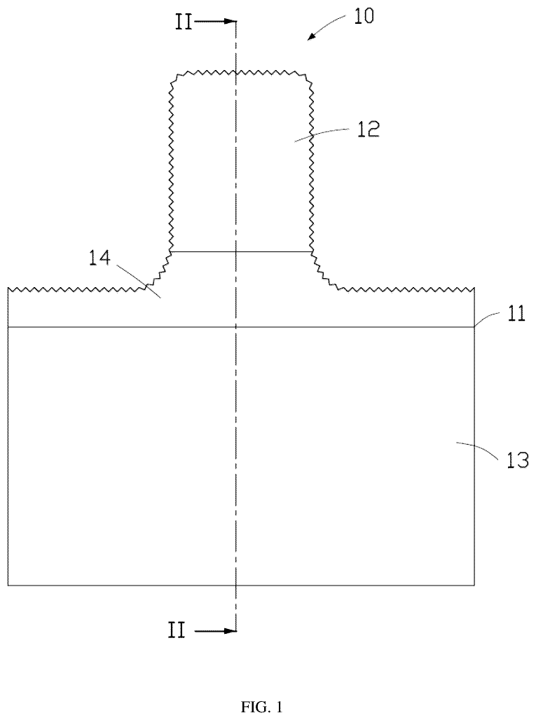

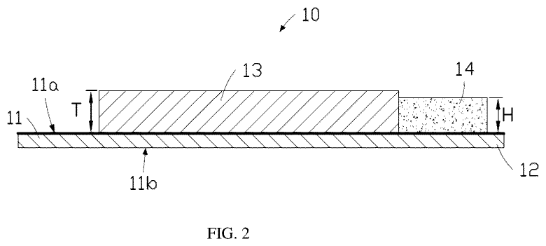

Referring to FIG. 1 and FIG. 2, the positive electrode plate 10 includes a current collector 11, a tab 12, an active material layer 13, and an insulation layer 14. The current collector 11 includes a first surface 11a and a second surface 11b which are oppositely disposed. The tab 12 protrudes from the side edge of the current collector 11 and is connected to the first surface 11a and the second surface 11b. The active material layer 13 is disposed on the first surface 11a and is separated from the tab 12. In other embodiments, the active material layer 13 may be disposed on the first surface 11a and the second surface 11b to increase the energy density. The insulation layer 14 is disposed on the first surface 11a along the side edge of the current collector 11 and abutted against the active material layer 13; the tab 12 protrudes from the side edge of the current collector 11; In the direction perpendicular to the first surface 11a (the thickness direction of the positive electrode plate 10), the thickness of the active material layer 13 is 200-400 μm, and the ratio of the thickness H of the insulation layer 14 to the thickness T of the active material layer 13 is 0.5-0.7.

The current collector 11 may be any positive current collector known in the art, for example, copper foil, copper alloy foil, a composite current collector, and the like. The tab 12 and the current collector 11 are formed into one-piece, for example, by cutting one sheet of copper foil.

The insulation layer 14 includes inorganic particles and a binder. The inorganic particles include one or more of aluminum oxide, boehmite, zirconium oxide, boron oxide, or hexagonal boron nitride. The binder includes one or more of polyvinylidene fluoride, a vinylidene fluoride-hexafluoropropylene copolymer, polyamide, polyacrylonitrile, polyacrylate, polyacrylic acid, polyacrylate or sodium carboxymethylcellulose.

The active material layer 13 includes an active material, a conductive agent and a binder. The active material includes one or more of lithium nickel cobalt manganese, lithium manganate, lithium iron phosphate, or lithium manganese iron phosphate. The conductive agent may be any conductive agent known in the art, for example, the conductive agent includes one or more of conductive Ketjen black, Super-P, acetylene black, graphene, carbon nanotubes, carbon fibers, and the like. The binder may be any binder known in the art, for example, the binder includes one or more of polyvinylidene fluoride, a vinylidene fluoride-hexafluoropropylene copolymer, polyamide, polyacrylonitrile, polyacrylate, polyacrylic acid, polyacrylate or sodium carboxymethylcellulose.

The active material layer 13 and the insulation layer 14 are prepared by a synchronous coating process. In some embodiments, a preparation method for the secondary battery includes the following steps: Dissolving the active material, the conductive agent and the binder in a solvent to form an active slurry with a solid content of greater than or equal to 65%, wherein the proportion of the active material is greater than or equal to 95.5%; dissolving the inorganic particles and the binder in a solvent to form an insulation slurry with a solid content of 30˜50%, wherein the proportion of the inorganic particles is greater than or equal to 80%; synchronously coating the active slurry and the insulation slurry on the surface of the current collector 11; drying an active slurry coating and an insulation slurry coating to form the active material layer 13 and the insulation layer 14 to prepare the positive electrode plate 10; and laminating or wounding the positive electrode plate 10, the separator, and the negative electrode plate to prepare the secondary battery. The solvent may, but is not limited to, include one or more of N-methylpyrrolidone, anhydrous ethanol, and acetone.

In this application, the thickness of the active material layer 13 is controlled to be 200-400 μm and the ratio of the thickness of the insulation layer 14 to the thickness of the active material layer 13 is controlled to be 0.5-0.7, so that the size of the interaction zone located at the junction position of the active material layer 13 and the insulation layer 14 formed by infiltration and mixing of the active slurry and the insulation slurry in the coating process can be reduced, and the effect of the interaction zone on the size of the electrode plate is improved.

When the ratio of the thickness H of the insulation layer 14 to the thickness T of the active material layer 13 is less than 0.5, the thickness difference between the insulation layer 14 and the active material layer 13 is too large, in the drying process, due to the fluidity of the active slurry and under the surface tension of the active slurry, the active slurry and the insulation slurry are prone to mix and melt at the boundary position to form the interaction zone, and the size of the interaction zone is too large, which has an effect on the size of the positive electrode plate 10. In addition, when the ratio of the thickness H of the insulation layer 14 to the thickness T of the active material layer 13 is less than 0.5, the thickness H of the insulation layer 14 may be small, and when the height of burrs formed by the cutting is greater than the thickness H of the insulation layer 14, the burrs will pierce the insulation layer 14, which may easily cause an internal short circuit in positive and negative electrodes and cause a safety problem.

When the ratio of the thickness H of the insulation layer 14 to the thickness T of the active material layer 13 is greater than 0.7, the thickness H of the insulation layer 14 is close to the thickness T of the active material layer 13, which makes it possible for the insulation layer 14 to be pressed in the cold pressing process of the secondary battery 100, and due to the inorganic particles having an incompressibility, the portion of the current collector 11 corresponding to the insulation layer 14 may be subjected to breakage by the pressure, which may lead to the problem of the cold-pressing tape breakage. In addition, when the ratio of the thickness H of the insulation layer 14 to the thickness T of the active material layer 13 is greater than 0.7, since the solid contents of the insulation slurry and the active slurry have a large difference, when the thickness of the insulation layer 14 is increased by increasing the coating weight (up to 740 mg/1540.25 mm²), the insulation layer is dried incompletely in the coating process, and adheres to a rubber roller, causing problems with scratches and tape breakage in the electrode plate.

In some embodiments, the ratio of the thickness H of the insulation layer 14 to the thickness T of the active material layer 13 is 0.6-0.7, which is more conductive to reducing the size of the interaction zone.

In some embodiments, the thickness of the active material layer is further controlled to be 200-370 μm, which is further conductive to reducing the size of the interaction zone.

In some embodiments, the thickness of the active material layer 13 is adjusted by controlling the coating weight of the active material layer 13 and the compaction density of the active material layer 13. In some embodiments, the coating weight of the active material layer 13 is 427-740 mg/1540.25 mm², and the compaction density of the active material layer 13 is 2.6-3 g/cm³. In this way, the active material layer 13 may be controlled to have a suitable thickness, which is conducive to reducing the size of the interaction zone. Preferably, the coating weight of the active material layer 13 is 427-640 mg/1540.25 mm², and in some embodiments, the thickness of the insulation layer 14 is adjusted by controlling the solid content of the insulation slurry and the coating weight of the insulation layer 14.

In some embodiments, the active material of the active material layer 13 is consist of the lithium manganate and the lithium iron phosphate, and a mass ratio of the lithium manganate to the lithium iron phosphate is 3.5-12. When the content of the lithium manganate is high, more gas is generated in the secondary battery. The mass ratio of the lithium manganate to the lithium iron phosphate is controlled to be 3.5-12, which makes both the width of the interaction zone and the thickness expansion rate of the secondary battery after storage more proper. In some embodiments, the active material includes the lithium manganate and the lithium iron phosphate, and the mass ratio of the lithium manganate to the lithium iron phosphate is 4-10, which further reduces the thickness expansion rate of the secondary battery after storage. In some embodiments, the active material of the active material layer 13 is consist of the lithium manganate and the lithium iron phosphate, and the mass ratio of the lithium manganate to the lithium iron phosphate is preferably 3.5-9, more preferably 3.5-7.65.

The negative electrode plate includes a negative current collector and a negative active material disposed on the surface of the negative current collector. The negative current collector may be any negative current collector known in the art, for example, copper foil, copper alloy foil, a composite current collector, and the like. The negative active material layer may be any negative electrode active material known in the art, for example, may include at least one of graphite, hard carbon, soft carbon, silicon, silicon carbon or silicon oxide. The negative active material may further include a conductive agent and a binder, the conductive agent may include at least one of conductive carbon black (Super P), carbon nanotubes (CNTs), carbon fibers, or graphene, etc., and the binder may include at least one of styrene-butadiene rubber (SBR), polyvinyl alcohol (PVA), polytetrafluoroethylene (PTFE), polyvinylidene difluoride (PVDF), or sodium carboxymethylcellulose (CMC-Na), etc.

The separator may be any separator known in the art. For example, the separator may be selected from a film made of one or more of polyethylene, polypropylene, nonwoven, or polyfiber.

The electrolytic solution may be any electrolytic solution known in the art. For example, the electrolytic solution is selected from an electron-insulating ion-conducting solution containing one or more of ethylene carbonate, propylene carbonate, dimethyl carbonate, diethyl carbonate, ethyl methyl carbonate, and other carbonate organic esters as a solvent, and one or more of lithium salts of TiPF₆, TiBF₄, TiBOB, TiAsF₆, Ti(CF₃SO₂)₂N, TiCF₃SO₃, and TiCTO₄ as a solute.

The shell may be any shell known in the art. For example, the shell may be a packaging bag obtained by encapsulation using an encapsulation film, such as an aluminum-plastic film, a steel-plastic film, and the like; or the shell may be a metal shell, such as a steel shell, an aluminum shell, and the like.

One embodiment of this application further provides an electronic apparatus, including the secondary battery of this application. The electronic apparatus may be any electrical device that uses an electrochemical apparatus, for example, the electronic apparatus may be a cell phone, a tablet, a laptop computer, a battery cart, an electric car, a ship, a spacecraft, an electric toy, an electric tool, and the like.

Some specific embodiments and comparative embodiments are listed below to better illustrate this application.

### Embodiment 1

Dispersing 9.64% lithium iron phosphate, 86.76% lithium manganate (the mass ratio of lithium manganate to lithium iron phosphate being 9), 0.6% conductive carbon slurry, 1.2% conductive carbon black, and 1.8% polyvinylidene fluoride in N-methyl-pyrrolidone to obtain an active slurry with a solid content of 67%. Dispersing 88% boehmite and 12% polyvinylidene fluoride in N-methyl-pyrrolidone to obtain an insulation slurry with a solid content of 35%. Coating the active slurry and the insulation slurry on aluminum foil to form an active coating and an insulation coating, the active coating and the insulation coating is abutted against each other, and the thickness of the active coating and the thickness of the insulation coating are equal. Drying the active coating and the insulation coating to obtain an active material layer and an insulation layer. Then after cold pressing, die cutting and slitting, a positive electrode plate as shown in FIG. 1 is obtained. The coating weight of the active material layer is 427 mg/1540.25 mm², the compaction density of the active material layer is 3 g/cm³, the thickness T of the active material layer is 200 μm, the thickness H of the insulation layer is 130 μm, and H/T is 0.65.

Mixing and coating the graphite, polyvinylidene fluoride, and conductive carbon black on the copper foil, and a negative electrode plate is obtained after cold pressing, die cutting, and slitting.

Stacking the positive electrode plate, a polyethylene separator, and the negative electrode plate in sequence, with the separator located between the positive electrode plate and the negative electrode plate to play a role of separation, and an electrode assembly is obtained after winding; placing the electrode assembly into an aluminum-plastic film and injecting liquid, followed by chemical formation, obtained a lithium-ion battery.

### Embodiments 2-11

Others are the same as Embodiment 1 except that at least one of the coating weight of the active material layer, the thickness T of the active material layer, the compaction density of the active material layer, the thickness H of the insulation layer, and H/T is different. T is 200-400 μm, and H/T is 0.5-0.7.

### Embodiments 12-17

Others are the same as Embodiment 3 except that the content of lithium manganate, the content of lithium iron phosphate, and the thickness H of the insulation layer are different.

### Embodiment 18

Others are the same as Embodiment 3 except that lithium iron phosphate, the coating weight of the active material layer, and the compaction density of the active material layer are different.

### Comparative Embodiments 1-5

Others of Comparative Embodiments 1-5 are the same as Embodiment 1 except for the coating weight of the active material layer, the thickness T of the active material layer, the compaction density of the active material layer, and the thickness H of the insulation layer.

The dimensions of the interaction zone in Embodiments 1-18 and Comparative embodiments 1-5 are observed and measured:

The positive electrode plate is taken and cut transversely with a slitting knife, the cross section is analyzed using a high-power microscope (SEM), and the white insulation layer, the black active material layer, and the gray interaction zone located between the white insulation layer and the black active material layer in the width direction of the positive electrode plate can be seen.

The distance from the highest point of the white insulation layer to the current collector is tested using the “point and line mode”. The above steps are repeated three times and an average value is solved as the thickness H of the insulation layer. In the width direction of the electrode plate, at a position 25-35 mm of lateral translation towards the inner side from the edge of the black active material layer, three points are taken to measure the distance from the surface of the white active material layer to the current collector, and then the average value is solved, i.e. the thickness T of the active material layer.

In the width direction of the electrode plate, the intersection point of the white insulation layer and the gray interaction zone is the starting point, and the intersection point of the black active material layer and the gray interaction zone is the end point, and the distance between two parallel lines is measured by using the “parallel line mode”, i.e. the width of the interaction zone, and the above steps are repeated three times to solve the average value, i.e. the measured width of the interaction zone.

The frequency of tape breakage of the positive electrode plate in the cold pressing process is observed.

When the width of the interaction zone is less than or equal to 0.5 mm, and the frequency of tape breakage is greater than or equal to 20000 m/time, it is judged to be within the acceptable range of the product and process, and the effect is “OK”; on the contrary, it is judged that the effect is “NG”.

The high-temperature storage performance of the lithium-ion battery of Embodiments 1-18 and Comparative Embodiments 1-5 is tested:

The lithium-ion battery is put in a 25° C. thermostat and stands for 5 minutes to bring the lithium-ion battery to a constant temperature. The lithium-ion battery is charged at 0.5 C constant current to 4.2 V, is charged at constant voltage to a current of 0.05 C, stands for 30 minutes, then is discharged at 0.2 C constant current to 2.8 V and stands for 5 minutes. The thickness of the lithium-ion battery is tested with a micrometer and recorded as the initial thickness. The tested lithium-ion battery is transferred to a 60° C. thermostat for storage for 60 days and then removed, placed in a 25° C. thermostat and left to stand for 5 minutes to allow the lithium-ion battery to reach a constant temperature, and the thickness of the lithium-ion battery is tested and used as the thickness after storage.

$$Thickness expansion rate = ( thickness after storage - initial thickness ) / initial thickness \times 100 \% .$$

Data and measurement results of Embodiments 1-18 and Comparative Embodiments 1-5 are as shown in Table 1A and Table 1B.

TABLE 1A

| | Mass | Mass | | | |
|---|---|---|---|---|---|
| | percentage of | percentage of | Mass ratio of | | |
| | lithium | lithium iron | lithium | Coating weight of | Thickness |
| | manganate in | phosphate in | manganate to | active material | T of active |
| | active material | active material | lithium iron | layer | material |
| | layer | layer | phosphate | (mg/1540.25 mm²) | layer (μm) |
| Embodiment 1 | 86.76% | 9.64% | 9 | 427 | 200 |
| Embodiment 2 | 86.76% | 9.64% | 9 | 504 | 250 |
| Embodiment 3 | 86.76% | 9.64% | 9 | 561 | 280 |
| Embodiment 4 | 86.76% | 9.64% | 9 | 640 | 317 |
| Embodiment 5 | 86.76% | 9.64% | 9 | 640 | 320 |
| Embodiment 6 | 86.76% | 9.64% | 9 | 640 | 328 |
| Embodiment 7 | 86.76% | 9.64% | 9 | 740 | 383 |
| Embodiment 8 | 86.76% | 9.64% | 9 | 740 | 370 |
| Embodiment 9 | 86.76% | 9.64% | 9 | 640 | 317 |
| Embodiment 10 | 86.76% | 9.64% | 9 | 640 | 322 |
| Embodiment 11 | 86.76% | 9.64% | 9 | 831 | 400 |
| Embodiment 12 | 75.30% | 21.10% | 3.57 | 561 | 280 |
| Embodiment 13 | 80.02% | 16.38% | 4.89 | 561 | 280 |
| Embodiment 14 | 85.25% | 11.15% | 7.65 | 561 | 280 |
| Embodiment 15 | 87.56% | 8.840% | 9.9 | 561 | 280 |
| Embodiment 16 | 89.08% | 7.32% | 12.17 | 561 | 280 |
| Embodiment 17 | 90.23% | 6.17% | 14.62 | 561 | 280 |
| Embodiment 18 | 0% | 96.4% | 0 | 459 | 280 |
| Comparative | 86.76% | 9.64% | 9 | 640 | 322 |
| Embodiment 1 | | | | | |
| Comparative | 86.76% | 9.64% | 9 | 740 | 369 |
| Embodiment 2 | | | | | |
| Comparative | 86.76% | 9.64% | 9 | 840 | 448 |
| Embodiment 3 | | | | | |
| Comparative | 86.76% | 9.64% | 9 | 400 | 185 |
| Embodiment 4 | | | | | |
| Comparative | 86.76% | 9.64% | 9 | 370 | 158 |
| Embodiment 5 | | | | | |

TABLE 1B

| | Compaction | | | | | | |
|---|---|---|---|---|---|---|---|
| | density of | Thickness | | | Frequency | | |
| | active | H of | | Width of | of tape | | Thickness |
| | material layer | insulation | | interaction | breakage | | expansion |
| | (g/cm³) | layer (μm) | H/T | zone (mm) | (m/time) | Effect | rate |
| Embodiment 1 | 3 | 130 | 0.65 | 0.15 | 20000 | OK | 7% |
| Embodiment 2 | 2.78 | 163 | 0.65 | 0.13 | 25000 | OK | 6.9% |
| Embodiment 3 | 2.75 | 182 | 0.65 | 0.15 | 25000 | OK | 7% |
| Embodiment 4 | 2.8 | 184 | 0.58 | 0.20 | 21000 | OK | 6.8% |
| Embodiment 5 | 2.77 | 208 | 0.65 | 0.19 | 25000 | OK | 6.8% |
| Embodiment 6 | 2.7 | 197 | 0.60 | 0.18 | 23000 | OK | 6.7% |
| Embodiment 7 | 2.65 | 199 | 0.52 | 0.35 | 20000 | OK | 6.8% |
| Embodiment 8 | 2.75 | 231 | 0.62 | 0.23 | 26000 | OK | 7.1% |
| Embodiment 9 | 2.8 | 222 | 0.70 | 0.13 | 23500 | OK | 6.8% |
| Embodiment 10 | 2.75 | 209 | 0.65 | 0.20 | 20000 | OK | 6.9% |
| Embodiment 11 | 2.7 | 204 | 0.51 | 0.4 | 21000 | OK | 6.9% |
| Embodiment 12 | 2.75 | 182 | 0.65 | 0.15 | 25000 | OK | 5.0% |
| Embodiment 13 | 2.75 | 182 | 0.65 | 0.14 | 25000 | OK | 5.5% |
| Embodiment 14 | 2.75 | 182 | 0.65 | 0.16 | 25000 | OK | 6.0% |
| Embodiment 15 | 2.75 | 182 | 0.65 | 0.15 | 25000 | OK | 8% |
| Embodiment 16 | 2.75 | 182 | 0.65 | 0.17 | 25000 | OK | 10.0% |
| Embodiment 17 | 2.75 | 182 | 0.65 | 0.15 | 25000 | OK | 13.0% |
| Embodiment 18 | 2.25 | 182 | 0.65 | 0.40 | 25000 | OK | 3.5% |
| Comparative | 2.75 | 129 | 0.40 | 2.0 | 20000 | NG | 7.1% |
| Embodiment 1 | | | | | | | |
| Comparative | 2.75 | 296 | 0.80 | 0.10 | 4500 | NG | 7.2% |
| Embodiment 2 | | | | | | | |
| Comparative | 2.55 | 381 | 0.85 | 0.08 | 3000 | NG | 7.1% |
| Embodiment 3 | | | | | | | |
| Comparative | 3.05 | 65 | 0.35 | 2.5 | 20000 | NG | 6.8% |
| Embodiment 4 | | | | | | | |
| Comparative | 3.04 | 98 | 0.62 | 0.17 | 5000 | NG | 7.0% |
| Embodiment 5 | | | | | | | |

Comparison of Embodiments 1-12 and Comparative Embodiments 1-5 shows that when the thickness T of the active material layer is 200-400 μm and the ratio H/T of the thickness H of the insulation layer to the thickness T of the active material layer is 0.5-0.7, the width of the interaction zone is 0.13-0.4 mm, and the frequency of tape breakage is 20,000-26,000 m/time, and the effect is OK. When H/T is 0.6-0.7, the width of the interaction zone is 0.13-0.23 mm, and the width of the interaction zone is even smaller.

As can be seen from Embodiments 3, and 12-17, when the thickness of the active material layer and the thickness of the insulation layer are within a suitable range, the mass ratio of the lithium manganate to the lithium iron phosphate has a relatively large effect on the high-temperature storage performance; when the mass ratio of the lithium manganate to the lithium iron phosphate is small, the thickness expansion rate after storage is small; and when the mass ratio of the lithium manganate to the lithium iron phosphate is large, the thickness expansion rate after storage is large. Furthermore, as can be seen from Embodiment 18, when the positive active material contains only the lithium iron phosphate, the width of the interaction zone becomes larger, and when the positive active material contains only lithium iron phosphate, the drying of the active layer is relatively fast, the drying rate of the insulation layer is slow, and the insulation layer flows toward the active layer under the action of capillary stress; and the lithium iron phosphate slurry has a high surface tension, and the edge of the positive active material layer shrinks in the drying process, resulting in the insulation layer slurry further flowing toward the positive active material layer and penetrating into the positive active material layer, so the interaction zone is wide.

The above disclosure is only a better implementation of this application, of course, cannot be used to limit this application, so the equivalent changes made in accordance with this application are still covered by the scope of this application.

What is claimed is:

1. A secondary battery, comprising a positive electrode plate, wherein the positive electrode plate comprises:
a current collector;
a tab, protruding from the current collector;
an active material layer, disposed on at least one surface of the current collector; and
an insulation layer, disposed along a side edge of the current collector and abutted against the active material layer; wherein the tab protrudes from the side edge of the current collector; wherein a ratio of a thickness of the insulation layer to a thickness of the active material layer is 0.5-0.7, and the thickness of the active material layer is 200-400 μm.

2. The secondary battery according to claim 1, wherein the ratio of the thickness of the insulation layer to the thickness of the active material layer is 0.6-0.7.

3. The secondary battery according to claim 1, wherein the thickness of the active material layer is 200-370 μm.

4. The secondary battery according to claim 1, wherein the thickness of the active material layer is 200-280 μm.

5. The secondary battery according to claim 1, wherein a coating weight of the active material layer is 427-740 mg/1540.25 mm².

6. The secondary battery according to claim 5, wherein the coating weight of the active material layer is 427-640 mg/1540.25 mm².

7. The secondary battery according to claim 1, wherein a compaction density of the active material layer is 2.6-3 g/cm³.

8. The secondary battery according to claim 1, wherein the insulation layer comprises inorganic particles; and the inorganic particles comprise one or more of aluminum oxide, boehmite, zirconium oxide, boron oxide, or hexagonal boron nitride.

9. The secondary battery according to claim 1, wherein the active material layer comprises an active material; and the active material comprises one or more of lithium nickel cobalt manganese, lithium manganate, lithium iron phosphate, or lithium manganese iron phosphate.

10. The secondary battery according to claim 9, wherein the active material comprises the lithium manganate and the lithium iron phosphate.

11. The secondary battery according to claim 10, wherein a mass ratio of the lithium manganate to the lithium iron phosphate is 3.5-12.

12. The secondary battery according to claim 10, wherein a mass ratio of the lithium manganate to the lithium iron phosphate is 3.5-9.

13. The secondary battery according to claim 10, wherein a mass ratio of the lithium manganate to the lithium iron phosphate is 3.5-7.65.

14. The secondary battery according to claim 10, wherein a mass ratio of the lithium manganate to the lithium iron phosphate is 4-10.

15. An electronic apparatus, comprising a secondary battery, the secondary battery, comprising a positive electrode plate, wherein the positive electrode plate comprises:
a current collector;
a tab, protruding from the current collector;
an active material layer, disposed on at least one surface of the current collector; and
an insulation layer, disposed along a side edge of the current collector and abutted against the active material layer; wherein the tab protrudes from the side edge of the current collector; wherein a ratio of a thickness of the insulation layer to a thickness of the active material layer is 0.5-0.7, and the thickness of the active material layer is 200-400 μm.

16. The electronic apparatus according to claim 15, wherein the ratio of the thickness of the insulation layer to the thickness of the active material layer is 0.6-0.7.

17. The electronic apparatus according to claim 15, wherein the thickness of the active material layer is 200-280 μm.

18. The electronic apparatus according to claim 15, wherein the active material comprises the lithium manganate and the lithium iron phosphate.

19. The electronic apparatus according to claim 18, wherein a mass ratio of the lithium manganate to the lithium iron phosphate is 3.5-12.

20. The electronic apparatus according to claim 19, wherein a mass ratio of the lithium manganate to the lithium iron phosphate is 3.5-9.
